(19) United States
(12) Patent Application Publication
(10) Pub. No.: US 2017/0308366 A1
(43) Pub. Date: Oct. 26, 2017

(54) SYSTEM AND OPERATING METHOD OF QUESTIONNAIRE STICKER

(71) Applicants: Nen-Fu Huang, Hsinchu (TW); Wei-Kuan Shih, Hsinchu (TW)

(72) Inventors: Nen-Fu Huang, Hsinchu (TW); Wei-Kuan Shih, Hsinchu (TW)

(21) Appl. No.: 15/350,740

(22) Filed: Nov. 14, 2016

(30) Foreign Application Priority Data
Apr. 22, 2016 (TW) 105112581

(51) Int. Cl. G06F 9/445; G06F 3/0488; G06F 3/14; G06F 3/0482; H04L 29/08

(52) U.S. Cl. CPC G06F 8/61; G06F 3/14; G06F 3/0482; G06F 3/04883; H04L 67/10

(57) ABSTRACT

A system and an operating method of a questionnaire sticker are disclosed. The system includes a sending end, a receiving end and a cloud server. The questionnaire initiator at the sending end creates a user group in the communication software program and selects a questionnaire sticker model with an option button, so as to form the questionnaire sticker, and then sends the questionnaire sticker to the cloud server. The questionnaire respondent at the receiving end also installs the communication software program and joins the user group. The cloud server sends the questionnaire sticker to the receiving end, and it is shown on a display interface. The response information is generated by directly selecting the option button, and is collected by the cloud server. The result of the questionnaire is then sent back to the sending end.

### CROSS-REFERENCE TO RELATED APPLICATION

This application claims priority from Taiwan Patent Application No. 105112581, filed on Apr. 22,2016, in the Taiwan Intellectual Property Office, the content of which is hereby incorporated by reference in its entirety for all purposes.

### BACKGROUND OF THE INVENTION

### 1. Field of the Invention

The present invention relates to a system and an operating method of a questionnaire sticker, more particularly to a questionnaire system and its operating method that combines sticker technology with a communication software program to conduct questionnaires in a more direct and convenient way.

### 2. Description of the Related Art

As technology has advanced, how questionnaires are conducted has changed from filling in paper-based questionnaires to using computers and transmission through a computer network to reduce time and cost. With reference to FIG. 1, a schematic view of the conventional way of conducting questionnaires, a questionnaire initiator 10 sends an email including the questionnaire or questionnaires to a plurality of questionnaire respondents 11˜14 via the Internet, so as to reduce the use and waste of printed paper, and the cost of mailing the paper questionnaire. The respondents 11˜14 may send back their responses directly to the initiator 10 by email, so as to expedite the collection of the questionnaire responses. However, the initiator 10 has to send out a number of emails corresponding to the number of respondents, then compile the same number of reply emails and compute the questionnaire results of the respondents 11˜14. If a respondent 13 has not replied with their responses to the questionnaire, then the initiator 10 has to try to contact the respondent 13 or resend the questionnaire to the respondent 13 by email again. For large numbers of respondents, the excessive workload will result in a poor efficiency of carrying out the survey.

Further to the aforementioned method and based thereon, there is a serial route method. In this method, the initiator 10 simply sends an email to the respondent 11, then, after confirmation, the respondent 11 automatically forwards the email to the next respondent, the respondent 12, and then to the next respondent, and this is repeated until the last respondent, the respondent 14 has received the email. A final result of the questionnaire, with all the respondents' responses, is returned to the initiator 10 after each of the respondents 11˜14 has completed the questionnaire and forwarded the email. Although this method no longer requires the initiator 10 to check that all respondents have completed and sent back the questionnaire, the method is unable to control the progress of filling the questionnaires. For example, if after a long time the respondent 13 has not completed the questionnaire, the initiator 10 will not know which particular respondent has not completed the questionnaire and forwarded the email on, and so the initiator 10 will be unable to effectively control the progress of the questionnaire.

In addition, cloud electronic documents are also used to conduct various types of surveys, and users may connect to a specific platform to jointly edit the same document, so that the questionnaire initiator just needs to process one document to obtain edits from collaborators when formulating the questionnaire and then another document with all the respondents' responses. However, this method still requires the initiator to notify the respondents one by one to connect to the specific platform, and the respondents might need to install a specific editor program for the operation. In general users may use a smartphone, a tablet computer, a notebook computer, or other devices, which may employ different operating systems and have different configurations that might not support the successful collaborative editing or the successful submission of responses by the respondents of the aforementioned survey type electronic document. And so this questionnaire method, while an improvement to the previously mentioned methods, still has these specific limitations.

Following extensive research and many years of experience in the field, the inventor of the present invention has developed a system and operating method of a questionnaire sticker that address the limitations of the prior art.

### SUMMARY OF THE INVENTION

In view of the aforementioned problems of the prior art, it is a primary objective of the present invention to provide a system and an operating method of a questionnaire sticker to address the limitations of the conventional questionnaire method, including the issues of heavy workload, low efficiency, and lack of convenience of the process when the number of respondents to the questionnaire is large.

To achieve the aforementioned objective, a questionnaire sticker system is provided, which includes a sending end, a receiving end, and a cloud server. The sending end installs a communication software program and a user group is created in the communication software program. The sending end further includes a questionnaire sticker database and an input interface. The questionnaire sticker database includes a plurality of questionnaire sticker models, and each questionnaire sticker model includes an option button, and the option button is in the form of a drawing or text that may be inside a square or other shaped box. The input interface is connected to the questionnaire sticker database, one of the questionnaire sticker models is selected from the questionnaire sticker database to form a questionnaire sticker, and the questionnaire sticker is sent to the cloud server. The receiving end is also installed with the communication software program, and is added to the same aforementioned user group of the communication software program. The receiving end further includes a display interface to display the questionnaire sticker. The cloud server is coupled to the sending end and the receiving end. The cloud server receives the questionnaire sticker and then sends the questionnaire sticker to the receiving end of the user group. The receiving end shows the questionnaire sticker on the display interface and response information is generated by directly selecting the option button. The response information is then sent to the cloud server. The cloud server collects and calculates the response information to form a questionnaire result, and the result is sent back to the sending end.

Preferably, the sending end may be connected to the questionnaire sticker server to update the plurality of questionnaire sticker models.

Preferably, the option button may include a numeric option drawing, a textual option drawing or a time option drawing.

Preferably, each of the plurality of questionnaire sticker models may include a sticker label, and a text or a drawing of the sticker label is edited by the sending end through the input interface to describe the content of the questionnaire sticker.

Preferably, the display interface may be a touch screen, and the option button displayed on the touch screen is directly clicked to select the desired options of the questionnaire sticker to generate the response information.

Preferably, the cloud server may include a timing device to generate a prompt message at the receiving end that has not provided a response to the questionnaire sticker after a predetermined time has elapsed since sending the questionnaire sticker from the sending end.

Preferably, the cloud server may include a counting device to compute the response information and form a questionnaire result after a predetermined proportion of the respondents have responded, and the questionnaire result is sent back to the sending end, and the prompt message is sent to the receiving end that has not provided a response to the questionnaire sticker.

To achieve the aforementioned objective, a questionnaire sticker operating method is provided. The operating method is applicable to the questionnaire sticker system, which includes a sending end, a receiving end, and a cloud server. The questionnaire sticker operating method includes the following steps: Installing a communication software program at the sending end and at the receiving end, creating a user group in the communication software program, and adding the sending end and the receiving end to the user group. At the sending end, selecting one of the plurality of questionnaire sticker models from a questionnaire sticker database, wherein the questionnaire sticker model includes an option button which is selected to form a questionnaire sticker that is then sent to the cloud server. At the cloud server, receiving the questionnaire sticker and sending the questionnaire sticker on to the receiving end of the user group. The questionnaire sticker is displayed on the display interface of the receiving end, and then the option button is directly selected from the display interface to generate response information. Lastly, at the cloud server, the response information is collected and calculated to form a questionnaire result, and the questionnaire result is then sent back to the sending end by the cloud server.

Preferably, the sending end may be connected to a questionnaire sticker server to update the plurality of questionnaire sticker models.

Preferably, the option button may include a numeric option drawing, a textual option drawing or a time option drawing.

Preferably, each of the questionnaire sticker models may include a sticker label, and a text or a drawing of the sticker label is edited by the sending end through the input interface to describe the content of the questionnaire sticker.

Preferably, the option button displayed on a touch screen is directly clicked by the receiving end to select the desired options of the questionnaire sticker to generate the response information.

Preferably, the cloud server may generate a prompt message and send the prompt message to the receiving end that has not provided a response to the questionnaire sticker after a predetermined time has elapsed since sending the questionnaire sticker from the sending end.

Preferably, the cloud server may compute the response information to form the questionnaire result after a predetermined proportion of the response information has been received, and the result of the questionnaire is sent back to the sending end, and a prompt message is sent to the receiving end that has not provided a response to the questionnaire sticker.

To summarize, the system and operating method of a questionnaire sticker of the present disclosure have one or more of the following advantages:

(1) The system and operating method of a questionnaire sticker involves the direct sending of the questionnaire sticker to each receiving end member of the user group, thus reducing the workload of sending many questionnaire forms, the workload of sending many emails, and the workload of processing a large quantity of data when collecting the responses of the questionnaire.

(2) The system and operating method of a questionnaire sticker allows for the direct selection of an option button from the questionnaire sticker at the receiving end, and then for the immediate sending back of the selected content to the cloud for a statistical analysis, without the need for a specific operation to send back all of the responses after completion of the questionnaire or the need to use a specific document editing program, thus simplifying the questionnaire filling process and making it much more convenient for the respondent.

(3) The system and operating method of a questionnaire sticker provides a cloud server to collect the response data, performs a statistical analysis of the response data, and returns the questionnaire result for review. The system and operating method may also be set to remind a respondent that has not responded, which helps the questionnaire initiator to increase the acquisition of responses and thus increasing the value of the survey or improve its completion success rate.

### BRIEF DESCRIPTION OF THE DRAWINGS

FIG. 1 is a schematic diagram illustrating the conventional way of conducting questionnaires;

FIG. 2 is a block diagram of a questionnaire sticker system in accordance with a preferred embodiment of the present invention;

FIGS. 3A and 3B are schematic views of a questionnaire sticker in accordance with a preferred embodiment of the present invention;

FIG. 4 is a schematic view of a questionnaire sticker server in accordance with a preferred embodiment of the present invention; and

FIG. 5 is a flow chart of a questionnaire sticker operating method in accordance with a preferred embodiment of the present invention.

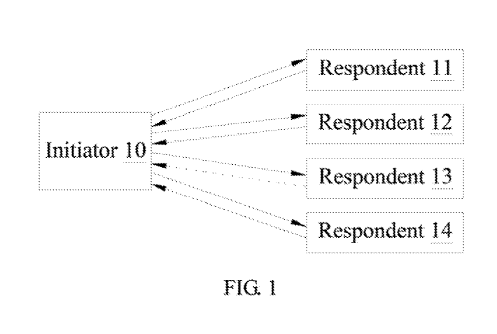

### DESCRIPTION OF THE PREFERRED EMBODIMENTS

The technical characteristics, implementation and advantages of the present invention are further explained in the following detailed description of the preferred embodiments, which refer to the accompanying drawings. It is, however, intended that the embodiments and figures disclosed herein are for the purpose of illustration only and shall not be interpreted in any way to limit the scope, applicability or configuration of the present invention.

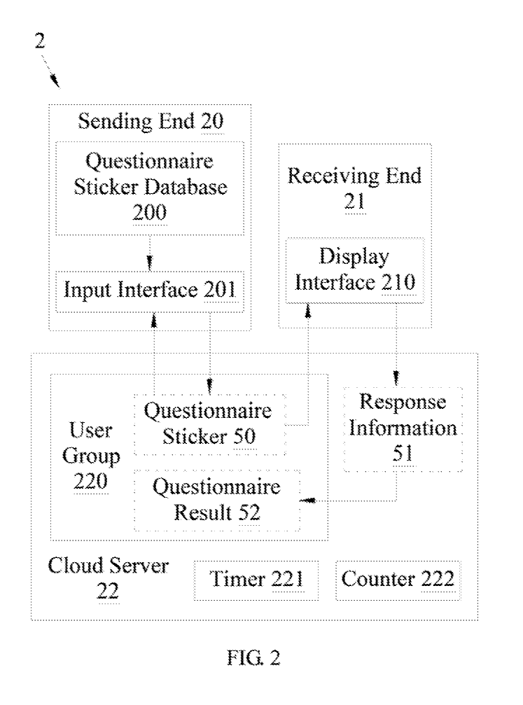

With reference to FIG. 2 that shows a block diagram of a questionnaire sticker system in accordance with a preferred embodiment of the present invention, the questionnaire sticker system 2 includes a sending end 20, a receiving end 21 and a cloud server 22. The sending end 20 is a device used by a questionnaire initiator and includes various types of electronic devices such as a smartphone, a tablet computer, a notebook computer, a desktop computer, or other device that is able to connect to the Internet. The receiving end 21 is a device used by a respondent and also includes various types of electronic devices such as a smartphone, a tablet computer, a notebook computer, a desktop computer, or other device that is able to connect to the Internet. A communication software program is installed at the sending end 20 and at the receiving end 21. A specific user group 220 is created in the cloud server 22, and the sending end 20 and the receiving end 21 are added as members of the user group 220.

The communication software programs of the present invention may be popular conventional application programs such as Line, WeChat, among others, or any sort of communication software program that can be installed in electronic devices that are able to transmit information to a server. In such a communication software program, a user may create several different user groups, like that of the user group 220, and add specific members to each user group as required. Using such a communication software program, the user may transmit information from the electronic device to the server, and the server transmits information to the user group, so that all the members of the user group receive the information simultaneously. In addition to the transmission of text messages, such communication software programs generally also include the function of transmitting stickers with graphical figures, video figures or animated figures to provide a more diversified and enriched communication between the members of the user group. However, these stickers are unidirectionally transmitted from a sender to a receiver only. On replying to the sender, text must be inputted again or another figure must be returned, and so this is a limitation.

In view of the aforementioned limitation, the present invention includes a questionnaire sticker database 200 disposed at the sending end 20. An option button with a reply function is added to the original pure drawing figure to create various types of questionnaire sticker models. When the questionnaire initiator at the sending end 20 wants to conduct a questionnaire, by using an input interface 201 a questionnaire sticker model is appropriately selected from the questionnaire sticker database 200. In other words, an appropriate option button is selected to form a questionnaire sticker 50 which is sent to the user group 220 of the cloud server 22. Then the cloud server 22 sends the questionnaire sticker 50 to each of the receiving ends 21 of the user group 220. The aforementioned input interface 201 includes a touch screen of an electronic device or a keyboard, a mouse, a touch panel, a sensor pen, or other input device to select a questionnaire sticker model from a display screen.

After the receiving end 21 of the user group 220 receives the sticker information, the questionnaire sticker 50 is displayed on the display interface 210. The display interface 210 is a touch screen provided for the user to directly click the option button on the questionnaire sticker 50 to generate response information 51, or alternatively, the display interface is a general display screen, where a keyboard, a mouse, a touch panel, a sensor pen, or other input device may be used to select the option button from the questionnaire sticker 50 to generate the response information 51. The plurality of option buttons may include an instruction to return information or a link to a specific website. When the option button is selected, a built-in automatic reply function will be enabled to send the selected result to the cloud server 22. Both of the sending end 20 and the receiving end 21 are connected to the cloud server through the Internet. The response information 51 generated by the different receiving end 21 is sent to the cloud server 22 and there undergoes a statistical analysis. Finally, the statistical results constitute the final questionnaire result, the questionnaire result 52, which is returned to the sending end 20 for the questionnaire initiator to review, and is also displayed to the user group 220 for the members of the user group 220 to review.

In the questionnaire process, the cloud server 22 may use an internal timer 221 or counter 222 to control the progress of the survey. For example, after the sending end 20 sends the questionnaire sticker 50 to the user group 220, the timer 221 immediately starts counting the survey time. After a predetermined time (such as 24 hours), the receiving end 21 of the user group 220 are checked for whether the option button has been selected, and a prompt message is sent to the receiving end 21 that have not made a selection on the questionnaire sticker 50. The prompt message method includes a text message of the communication software program, a short message of the telecommunication network, an email, or other form of message transmission; or the questionnaire sticker 50 is resent to remind the receiving end 21 to provide a response to the questionnaire. In another method, a counter 222 is used to count the number of the replied questionnaire stickers 50. If the proportion of the replied questionnaire stickers 50 reaches a predetermined value (such as a proportion at or above 80% of the total number of respondents), the cloud server 22 will compute the data collected up to that point and generate a preliminary questionnaire result 52 and return the preliminary questionnaire result 52 to the sending end 20 for review. Also, as with the timer 221 method, a prompt message is sent to the receiving end 21 that have not made a selection on the questionnaire sticker 50, and as before the prompt message includes a text message, a short message, an email, or other form of message transmission. For any further replies, or when all respondents have made a selection on the questionnaire sticker 50, the cloud server 22 will return the updated questionnaire result 52 to the sending end 20. The cloud server 22 includes a receiver connected to the Internet, a memory component to store data, and a processor to carry out the statistical analysis. The timer 221 and the counter 222 may be in form of software or hardware and execute their function in the cloud server 22.

In addition, the timer 221 of the cloud server may be provided for the sending end 20 to set the time for starting and ending the questionnaire. For example, after the receiving end 21 of the user group receives the content and description, the content and description will be displayed and the survey will start. The questionnaire sticker 50 is sent to the receiving end 21 and then the function of generating the response information 51 is enabled at the starting time. Alternatively, the questionnaire sticker 50 is sent to the receiving end directly at the starting time. After the predetermined survey time ends, the questionnaire result 52 will be sent from the cloud server 22 to the sending end 20, or displayed to the user group 220. Before the survey time ends, a function may be set to remind the receiving end 21 that have not responded to complete the questionnaire survey before the deadline. At specific points in time, according to the predetermined settings of automatically processing the collected response information 51, the sending end 20 or any of the receiving ends 21 may actively inquire the current questionnaire result 52. The members of the user group 220, including the questionnaire initiator at the sending end 20, are able to see who the other members are, so when the questionnaire result 52 shows that a member at the receiving end 21 has not responded, the sending end 20 may actively send a text or drawing message to remind the respondent at the specific receiving end 21 to complete the questionnaire as soon as possible. The questionnaire sticker 50 will be described in detail in the following embodiments.

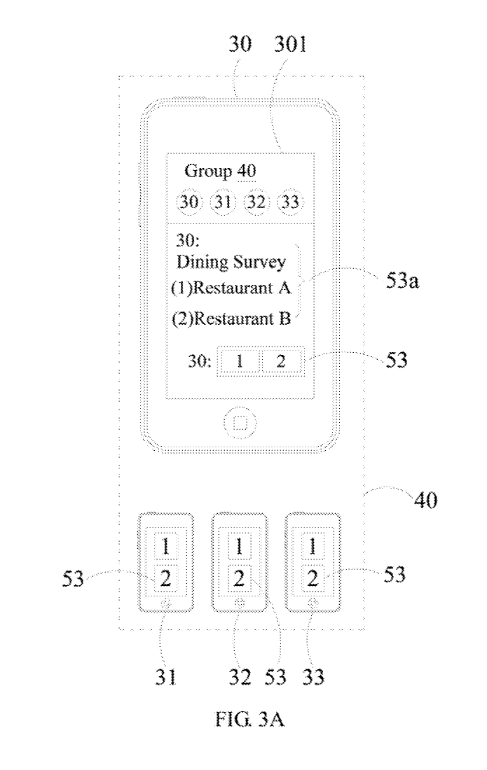

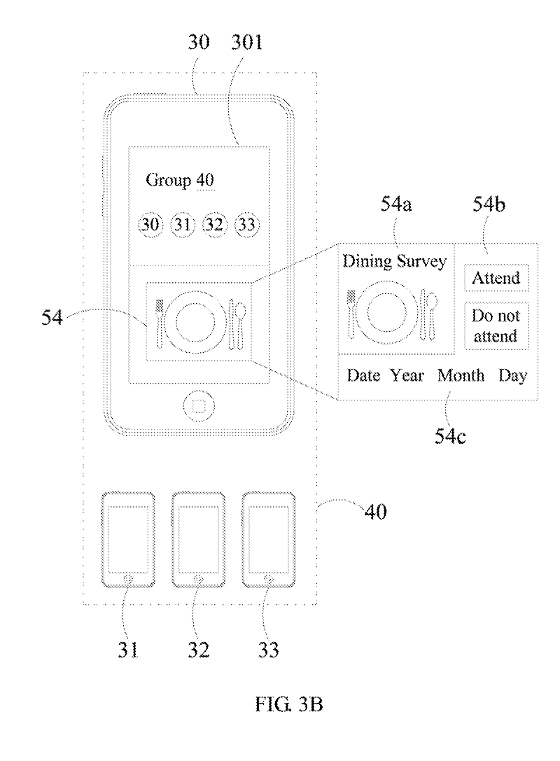

With reference to FIGS. 3A and 3B that show schematic views of a questionnaire sticker in accordance with a preferred embodiment of the present invention, the questionnaire initiator installs the communication software program at the sending end 30 and creates a user group 40 in the communication software program, wherein the user group 40 may be a combination of members of a school or of an institute, members of a department of a company, or members of a family. To ensure the integrity of the user group 40 and for the safety of its members, a vetting procedure may be added when creating the user group, so that a member is added to the user group 40 only after passing a vetting test. The official account in the communication software program may also be used as an extended user group 40. The official account can be established in advance, and the user which installs the communication software program can join this account. For implementations, the user group 40 may be created individually in the official account. When the questionnaire sticker is required, the questionnaire sticker model can be chosen from the official account and then sent to the group members, such that the questionnaire sticker can be operated in the group of the official account. After the user group 40 has been successfully created, the input interface 301 of the sending end 30 displays the members of the user group 40 including the sending end 30 and a plurality of receiving ends 31˜33 as shown in the figure, wherein the number of receiving ends 31˜33 is not limited to three as in this preferred embodiment. The number of receiving ends may be adjusted according to the requirements of different types of groups. In this preferred embodiment, three receiving ends 31˜33 are used for the purpose of illustrating the present invention only.

One possible implementation, as shown in FIG. 3A, is a questionnaire on choosing the restaurant for the dining occasion. Other possible related questionnaires could be used for determining the willingness of dining together, finding a suitable meeting time, or reviewing a proposal. For the present embodiment as shown in FIG. 3A, the questionnaire initiator at sending end 30 selects an appropriate questionnaire sticker model from the questionnaire sticker database. For instance, if the members of an institute would like to dine together, a secretary, assistant or representative of the institute can act as the initiator at the sending end 30. The initiator selects a questionnaire sticker model for a dining survey, and the questionnaire sticker model includes a set of option buttons that includes, for example, option buttons 1 and 2 (or A and B). The initiator at the sending end 30 may describe the choice of restaurants via a text message 53a and then the initiator sends out, from the sending end 30, the questionnaire sticker 53 that includes the option buttons 1 and 2. After that, the cloud server passes on the text message 53a and the questionnaire sticker 53 to each of the receiving ends 31˜33 of the user group 40. The receiving ends 31˜33 display the questionnaire sticker 53 on the display interface, and each respondent may tap, click or select the option button representing the first option or the option button representing the second option. The response information 51 containing the selected option is sent to the cloud server, and then a statistical analysis of the response information 51 for each receiving end 31˜33 that has provided a response is carried out by the cloud server, without the need for the initiator at the sending end 30 or the device at the sending end 30 to collect the response information 51 one by one. This significantly improves the efficiency of the survey process.

With reference to FIG. 3B that shows a schematic view of a questionnaire sticker in accordance with a preferred embodiment of the present invention, the questionnaire initiator at the sending end 30 selects a survey questionnaire sticker model, in this preferred embodiment a survey proposing a dining occasion. The questionnaire sticker model includes a title in the form of the sticker label 54a and an option button 54b including one or more sets of buttons that form the choices to be selected by the questionnaire respondents at the receiving ends 31˜33. The initiator at sending end 30 may input the content of the option button 54b and any description of the dining activity through the input interface 301. The option button 54b includes a textual drawing, such as “attend” or “do not attend”. The option button 54b also includes a time option 54c. The time option 54c may be in the form of a dropdown menu to select a date and time, or in the form of a calendar and a clock, with the date and time to be selected by the receiving ends 31˜33. This option button 54b is combined with the original graphical sticker label 54a to form the questionnaire sticker 54. The sending end 30 sends the questionnaire sticker 54, then the cloud server sends the questionnaire sticker 54 to the user group 40, and the receiving ends 31˜33 display the questionnaire sticker 54 on the device. In this way, the tedious process of sending the survey emails or short messages one by one is avoided. Each of the receiving ends 31˜33 may use a touch screen for the respondent to directly click the option button 54b and then the response information of the chosen selections is sent back to the cloud server. Alternatively, any of the receiving ends 31˜33 may use a mouse, a keyboard or other input interface for the respondent to make the selection. The sending back of the response is automatic and directly follows the selection of an option at the receiving ends 31˜33, and so in this way, the invention further simplifies the respondent's reply process and makes the questionnaire process more efficient.

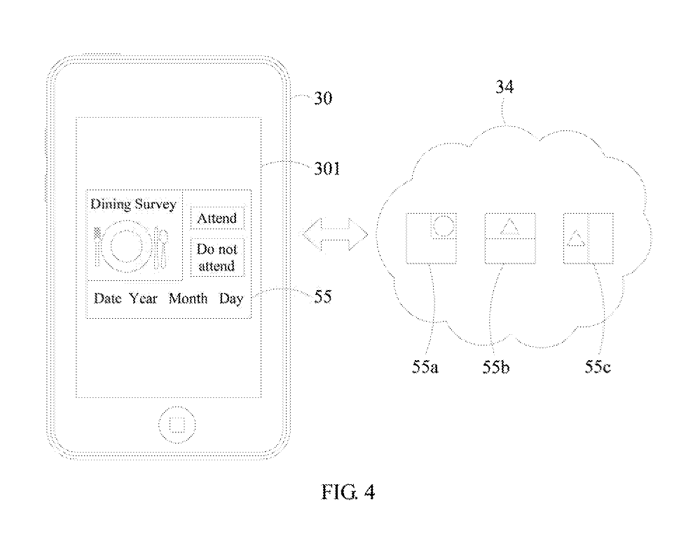

With reference to FIG. 4 that shows a schematic view of a questionnaire sticker server in accordance with a preferred embodiment of the present invention, the questionnaire initiator at the sending end 30 selects an appropriate questionnaire sticker model and inputs the questionnaire content by using the input interface 301 to form a questionnaire sticker 55. As described in the previous preferred embodiment, the questionnaire sticker may include different types of survey content, such as determining the willingness of dining together, finding a suitable meeting time, or reviewing a proposal. The questionnaire sticker models may vary in their design, and what is more, the sticker label of the questionnaire corresponding to the questionnaire topic and the option button corresponding to the questionnaire content may each vary independently according to what is needed. The local questionnaire sticker database at the sending end 30 may only contain a basic set of commonly used questionnaire sticker models, such as the numeric option drawing or the textual option drawing. Therefore, when a new questionnaire topic or a specific content option are required, these can be added to the local questionnaire sticker database as needed by connecting to the questionnaire sticker server 34 and updating the questionnaire sticker models 55a-55c from the questionnaire sticker server 34. The questionnaire sticker model 55a may be templates with different layout design, the questionnaire sticker model 55b may be templates with different questionnaire topic, and the questionnaire sticker model 55c may be templates having specific layout design and option button. The provider of the service of the communication software program may add to, remove, or update the questionnaire sticker models available, based on holidays, festivals, other current events, or other special transitory offerings, such as promotions, in order to make the offering of questionnaire stickers more attractive and useful for the user.

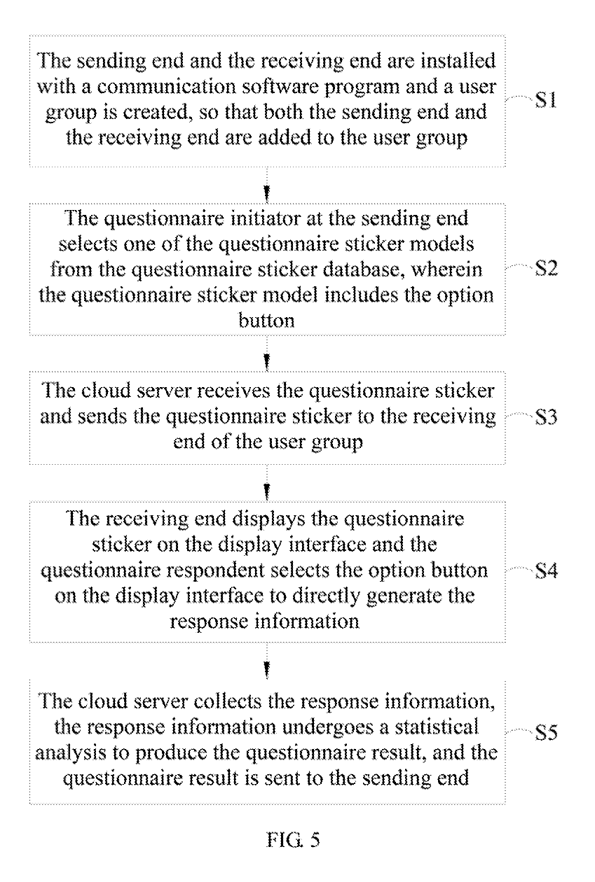

With reference to FIG. 5 that is a flow chart of a questionnaire sticker operating method in accordance with a preferred embodiment of the present invention, the questionnaire sticker operating method comprises the following steps (S1˜S5):

S1: The sending end and the receiving end are installed with a communication software program and a user group is created, so that both the sending end and the receiving end are added to the user group. More specifically, as shown in FIGS. 3A or 3B, the questionnaire initiator installs the communication software program at the sending end 30, the questionnaire respondents install the communication software program at the receiving ends 31˜33, and the newly created user group 40 acts as a platform for conducting the questionnaire. The members of the user group 40 may transmit and receive information to and from one another, and information may be transmitted or received within the group through the members' handheld devices or other electronic devices.

S2: The questionnaire initiator at the sending end selects one of the questionnaire sticker models from the questionnaire sticker database, wherein the questionnaire sticker model includes the option button. If the questionnaire initiator wants to conduct a questionnaire by using a questionnaire sticker, the questionnaire initiator at the sending end 20 will select an appropriate sticker from the questionnaire sticker database. More specifically, the questionnaire content description is inputted, followed by the selection of one or more sets of option buttons to produce the questionnaire sticker 53, which is then sent to the cloud server. In another embodiment, a ready-made sticker label 54a with a suitable questionnaire title and a suitable option button 54b is chosen as the template of the questionnaire sticker. The template may include basic question and response options, which may include textual options, numeric options and time options. The selected sticker label 54a and option button 54b may have their content added or amended by editing through the input interface 301 of the sending end 30, such that the questionnaire sticker 54 is formed and sent to the cloud server to initiate the survey.

S3: The cloud server receives the questionnaire sticker and sends the questionnaire sticker to the receiving end of the user group. More specifically, the cloud server receives the questionnaire sticker transmitted from the sending end 30, and the questionnaire sticker is sent to the user group 40, so that the receiving ends 31˜33 can see the contents of the questionnaire sticker 53 or 54 directly after receiving the questionnaire sticker 53 or 54.

S4: The receiving end displays the questionnaire sticker on the display interface and the questionnaire respondent selects the option button on the display interface to directly generate the response information. More specifically, when the receiving ends 31˜33 each display the questionnaire sticker 53 or 54, the respondents at the receiving ends 31˜33 may directly tap on, click on or select one or more of the option buttons of the questionnaire sticker and this selection forms the response information, which is immediately sent to the cloud server.

S5: The cloud server collects the response information, the response information undergoes a statistical analysis to produce the questionnaire result, and the questionnaire result is sent to the sending end. More specifically, the cloud server receives the response information transmitted by each receiving ends 31˜33 and stores the response information in the server to carry out a statistical analysis on the data of the response information. If the condition of a predetermined point in time of the survey or of the proportion of the survey completed is satisfied, the questionnaire result will be sent to the sending end 30. In this way, the questionnaire initiator obtains the survey result.

While this disclosure has been described by means of specific embodiments, numerous modifications and variations could be made thereto by those skilled in the art without departing from the scope and spirit of this disclosure set forth in the claims.

What is claimed is:

1. A questionnaire sticker system, comprising:
a sending end, installing a communication software program, and a user group being created in the communication software program, the sending end further comprising:
a questionnaire sticker database, comprising a plurality of questionnaire sticker models, each comprising an option button; and
an input interface coupled to the questionnaire sticker database, being provided for selecting one of the plurality of questionnaire sticker models from the questionnaire sticker database to form a questionnaire sticker;
a receiving end, installing the communication software program, and being added to the user group of the communication software program, the receiving end comprising a display interface to display the questionnaire sticker; and
a cloud server coupled to the sending end and the receiving end, being provided for receiving the questionnaire sticker and transmitting the questionnaire sticker to the receiving end of the user group, wherein the questionnaire sticker is shown on the display interface and response information is generated by directly selecting the option button on the display interface, and then the response information is collected and calculated by the cloud server to form a questionnaire result, and the questionnaire result is sent back to the sending end.

2. The questionnaire sticker system according to claim 1, wherein the sending end is connected to a questionnaire sticker server to update the plurality of questionnaire sticker models.

3. The questionnaire sticker system according to claim 1, wherein the option button comprises a numeric option drawing, a textual option drawing or a time option drawing.

4. The questionnaire sticker system according to claim 1, wherein each of the plurality of questionnaire sticker models comprises a sticker label and a text or a drawing of the sticker label is edited by the sending end through the input interface to describe the content of the questionnaire sticker.

5. The questionnaire sticker system according to claim 1, wherein the display interface is a touch screen and the option button displayed on the touch screen is directly clicked to select the desired options of the questionnaire sticker to generate the response information.

6. The questionnaire sticker system according to claim 1, wherein the cloud server includes a timing device providing for the generating of a prompt message at the receiving end that has not provided a response to the questionnaire sticker after a predetermined time has elapsed since sending the questionnaire sticker from the sending end.

7. The questionnaire sticker system according to claim 1, wherein the cloud server includes a counting device providing for the computing of the response information to form the questionnaire result after a predetermined proportion of the response information has been received, and the questionnaire result is sent back to the sending end and a prompt message is sent to the receiving end that has not provided a response to the questionnaire sticker.

8. A questionnaire sticker operating method, applicable to a questionnaire sticker system, comprising a sending end, a receiving end, and a cloud server, and the operating method comprising the steps of:
installing a communication software program at the sending end and at the receiving end, creating a user group in the communication software program, and adding the sending end and the receiving end to the user group;
selecting one of a plurality of questionnaire sticker models from a questionnaire sticker database by the sending end, wherein the plurality of questionnaire sticker models comprises an option button, forming a questionnaire sticker and sending the questionnaire sticker to the cloud server;
receiving the questionnaire sticker and sending the questionnaire sticker to the receiving end in the user group by the cloud server;
selecting the option button directly from a display interface of the receiving end to generate response information, wherein the questionnaire sticker is shown by the display interface of the receiving end; and
collecting and calculating the response information to form a questionnaire result, and sending the questionnaire result back to the sending end by the cloud server.

9. The questionnaire sticker operating method according to claim 8, wherein the sending end is connected to a questionnaire sticker server to update the plurality of questionnaire sticker models.

10. The questionnaire sticker operating method according to claim 8, wherein the option button comprises a numeric option drawing, a textual option drawing or a time option drawing.

11. The questionnaire sticker operating method according to claim 8, wherein each of the plurality of questionnaire sticker models comprises a sticker label and a text or a drawing of the sticker label is edited by the sending end through the input interface to describe the content of the questionnaire sticker.

12. The questionnaire sticker operating method according to claim 8, wherein the option button displayed on a touch screen is directly clicked by the receiving end to select the desired options of the questionnaire sticker to generate the response information.

13. The questionnaire sticker operating method according to claim 8, wherein the cloud server generates a prompt message and sends the prompt message to the receiving end that has not provided a response to the questionnaire sticker after a predetermined time has elapsed since sending the questionnaire sticker from the sending end.

14. The questionnaire sticker operating method according to claim 8, wherein the cloud server computes the response information to form the questionnaire result after a predetermined proportion of the response information has been received and the questionnaire result is sent back to the sending end and a prompt message is sent to the receiving end that has not provided a response to the questionnaire sticker.
